(19) United States
(12) Patent Application Publication
(10) Pub. No.: US 2011/0132944 A1
(43) Pub. Date: Jun. 9, 2011

(54) DENTAL LANYARD DEVICE

(76) Inventor: Karlis Gravitis, St. Catharines (CA)

(21) Appl. No.: 12/633,120

(22) Filed: Dec. 8, 2009

(51) Int. Cl. A45F 5/00; A61C 19/00

(52) U.S. Cl. 224/267

(57) ABSTRACT

The present invention relates to a lanyard device. Specifically, the present invention describes a lanyard device for dental procedures which prevents dental tools or dental debris from descending in an unrestrained manner down a patient's throat. The dental lanyard comprising a restraining strap with both a first end and a second end so that the first end may be threaded through a loop formed at the second end so as to define a restraining loop which may be affixed to the individual patient or dentist, a swivel member that may be attached to the first end of the restraining strap and a fastening means attached to the opposite end of swivel member wherein the fastening means may also secure the dental device.

### FIELD OF INVENTION

The present invention relates to a lanyard device. Specifically, the present invention describes a lanyard device for dental and dental implant procedures which prevents dental tools from descending in an unrestrained manner down a patient's throat.

### BACKGROUND OF INVENTION

Incidents of aspiration and ingestion of dental instruments, materials or prostheses are well documented in the available literature. The manufacturers of dental instruments in addition to the American Dental Association recommend the use of preventive measures such as rubber dams, gauze throat screens or floss ligatures when performing dental procedures.¹

Specifically, a rubber dam is a thin square shaped piece of latex or silicone that mainly function to isolate the tooth being treated from its environment, in particular from the bacteria in the oral cavity. The rubber dam is held over individual teeth or groups of teeth by appropriate rubber dam clamps or threads (ligatures) along the edge of the gum. The tooth crown stands out from the rubber dam through individual holes made by a hole punch. This permits a clean and dry operative field, wherein the patient's lips and cheeks are retracted thereby enabling treatment of the appropriate tooth without contamination from blood or saliva. Additionally, another function of a rubber dam is to protect the patient's airway from any materials which may get inadvertently dropped during the treatment.

While rubber dams may prevent materials from being lost down a patient's throat, the routine use of dental dams is not always appropriate. Rubber damns greatly impede the communication between the practitioner and the patient. In addition, the preparation and subsequent setting up of the rubber dam for use in a dental procedure (clamps and ligatures) can be time consuming and uncomfortable to the patient. This additional time and lack of comfort has led to numerous patients having reported that they feel restricted.

A less invasive embodiment of the rubber dam concept is disclosed in U.S. Pat. No. 5,931,673 (hereinafter Bolbolan) which describes inter alia an intraoral dental dam including an elastic membrane attached to a resilient frame. The membrane having an upper, a lower, a middle portion corresponding to the oral cavity of the user, the middle portion extending between the upper and lower portions, and a perimeter. The dental dam can be disposed in a patient's mouth such that the upper portion rests against at least a portion of the palate, the lower portion rests over at least a portion of the tongue, the middle portion substantially blocking the oral cavity in such a manner as to leave the teeth substantially exposed.

A gauze throat screen as the name implies requires the practitioner to manually insert layers of gauze as a barrier to prevent any errant dental tools from descending down the patient's throat. While these throat screens can be readily available, most patient's do not tolerate the placement of a cotton barrier in the back of the throat without an increase of anxiety, discomfort and gagging.

Similarly, the prior art U.S. Pat. No. 7,140,881 (hereinafter Gealon) provides a throat screen which can be placed in a dental patient's mouth during dental procedures. The throat screen is comprised of a central porous area, with openings sufficiently numerous and of sufficient size to permit patient breathing through the mouth and draining of excess saliva into the throat but small enough to prevent the passage into the throat of any debris produced during the dental procedures or small dental tools used during the procedures. As previously discussed, this recommendation still involves the placement of a relatively invasive device inside the patient's mouth.

Thirdly, manufacturers and clinicians recommend tying floss ligatures to secure any dental tools that may find its way into the throat of a patient. Unfortunately, when dental tools are used with floss attached, the floss threads tend to wrap around the operator's fingers and/or the tool itself. This necessitates the periodic disentanglement of the tool from the floss, which is inconvenient, inefficient and cumbersome. Floss may also shred or break, when rubbed against the edges of the tool, making this an unpredictable safety measure. This last recommendation requires the practitioner to thread and tie floss through every device to be used during the dental procedure so as to restrain the device from falling down the patient's throat. This last recommendation while less invasive to the patient still requires an avoidable investment of time from the practitioner.

In terms of prior art, lanyards have been combined with hand tools for quite some time. U.S. Pat. No. 6,487,756 (hereinafter Vidal) discloses a hand tool and lanyard combination comprised of a hand tool to which a lanyard is removably attached. The lanyard is a length of flexible cable having an anchor and a free end. The anchor end has a housing with a spring mounted rotatable spool disposed within the housing so that the length of flexible cable is retractable by the rotation of the rotatable spool. The free end has a free end attachment mechanism for removable attaching the free end to the hand tool.

Taking the lanyard concept and combining it with dental tools, U.S. Pat. No. 6,116,252 discloses a finger-mounted disposable toothbrush including a lanyard of dental floss, a first end of which is attached to the toothbrush and a second end of which is looped around a user's wrist. The dental floss lanyard prevents swallowing of the toothbrush during use and can also be used for flossing the user's teeth after brushing.

Accordingly, there is a need for a non-invasive, patient friendly device that prevents dental tools and related items from falling down a patient's throat. Specifically, the device should be non-irritating to the patient without inducing the gag reflex, and the device should minimize the risk of entanglement with the dental tool that is being used. Further, the device should be reusable, and sterilizable.

The present invention addresses all of these criteria and is relatively easy to use without requiring extensive time from the practitioner to set up before the procedure.

### SUMMARY OF INVENTION

In accordance with one preferred embodiment, a dental lanyard device is disclosed. The dental lanyard comprising a restraining strap with both a first end and a second end so that the first end may be threaded through a loop formed at the second end so as to define a restraining loop which may be affixed to the individual patient or dentist, a swivel member that may be attached to the first end of the restraining strap and a fastening means attached to the opposite end of swivel member wherein the fastening means may also secure the dental device.

In accordance with a further preferred embodiment, the dental lanyard device is disclosed where the fastening means is selected from the group consisting of clasps, split rings, break-away clasps, R-clip or hairpin clip.

In accordance with yet a further preferred embodiment, the dental lanyard may be made from materials selected from the group consisting of plastic, silicone, rubber and metal

In accordance with another preferred embodiment, the restraining loop may be affixed to a wrist of an individual either the dental practitioner or the patient depending on the procedure.

In yet another preferred embodiment, the dental device may be selected from the group consisting of wrenches, drivers, endodotic files, reemers or x-ray holders.

In still another preferred embodiment, the dental device is a patient's tooth and the fastening means encompasses bonding a dental bracket to the patient's tooth so as to restrain it from falling down the patient's throat.

In accordance with another preferred embodiment, a dental lanyard for attachment to a dental device is disclosed comprising a restraining strap with a free end and an anchor end affixed to a spring-mounted rotatable spool so that the free end is retractable by the rotation of the rotatable spool, a restraining loop connected to the rotatable spool and operable to be affixed to an individual, a swivel member with a first end and a second end wherein the first end is attached to the first end of the restraining strap and a fastening means attached to the second end of the swivel member wherein the fastening means may also secure the dental device.

In yet another preferred embodiment, the fastening means of the restraining loop may be selected from the group consisting of Velcro, zipper, clasp, elasticized loop or laced mechanism.

Other features and embodiments of the present invention will become apparent to those skilled in art from the following detailed description. It is to be appreciated, however, that the detailed description and specific examples, while indicating the preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

FIG. 1: A front view of the dental lanyard engaged around a practitioner's wrist.

FIG. 2: A front view of the clasp, swivel member and the restraining strap.

FIG. 3: The front of the elements from FIG. 2 attached to a dental device (wrench).

In the figures, like numerals refer to like elements throughout the aforementioned views of the present invention.

### DETAILED DESCRIPTION

Foreign body ingestion or aspiration episodes are potential complications in all branches of medicine including dentistry. The handling and operation of small dental devices requires considerable attention and particular care considering the patient is often in a supine or semi-recumbent position. To further contribute to the difficulties faced by the dental practitioner, the dental devices may become quite slippery and difficult to handle when coated with a patient's saliva or blood. In addition, a patient undergoing a procedure may be susceptible to components becoming detached or fractured during the dental procedure.²

Cases have been reported that demonstrate the potentially disastrous complications of aspiration or ingestion of foreign objects in dental practice. In an article appearing in “The Journal of the American Dental Association”, a study was referenced from the School of Dentistry, The University of North Carolina at Chapel Hill during a 10 year period (1992-2002).³ During this provided time frame, the study reported 36 cases of aspiration or ingestion. In 2006, a Florida case involving the dropping of a dental screwdriver resulted in the death of the dental patient.⁴

In a similar manner, the dental procedures themselves that resulted in patient aspiration/ingestion were quite varied and included implant surgery, prostethics, prosthodontics, orthodontic/pediatric dentistry, restorative dentistry, oral maxillofacial surgery, endodontics, dental hygiene, special care dentistry and periodontics.

With all of the associated and contributing risk factors, the literature concurs that prevention of an aspiration/ingestion incident is paramount. The present invention discloses such a preventive measure.

In general, the present invention is directed to a reusable dental lanyard 1 that may be connected to a dental device 17 comprising a restraining loop 3, a swivel member 11 and a fastening means 15 to the dental device 17.

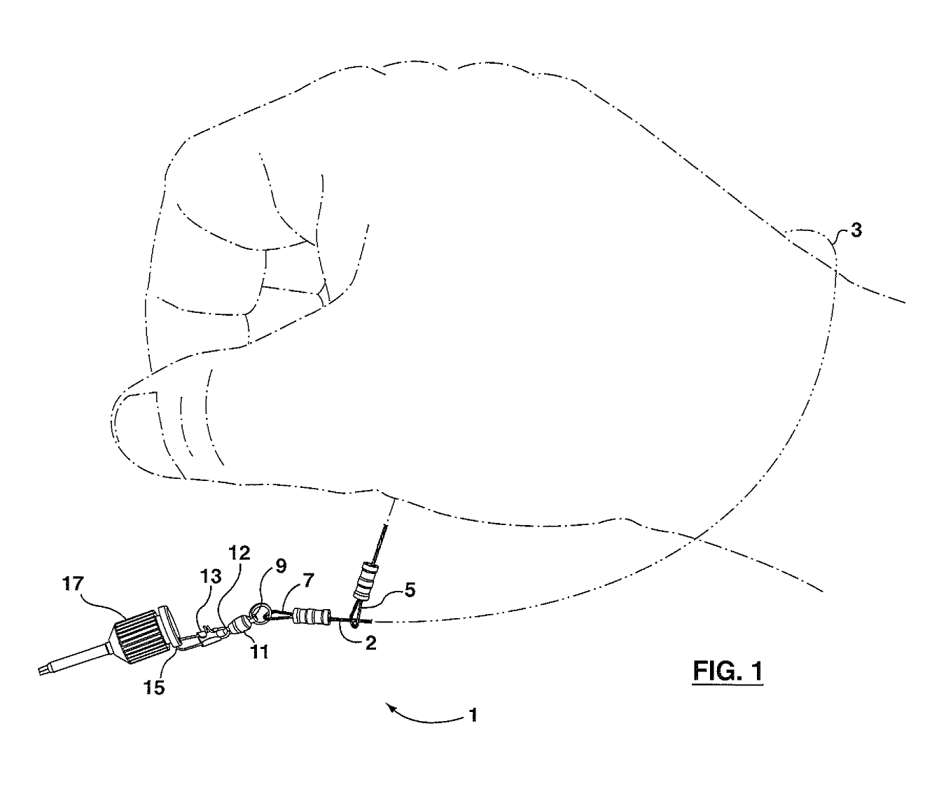

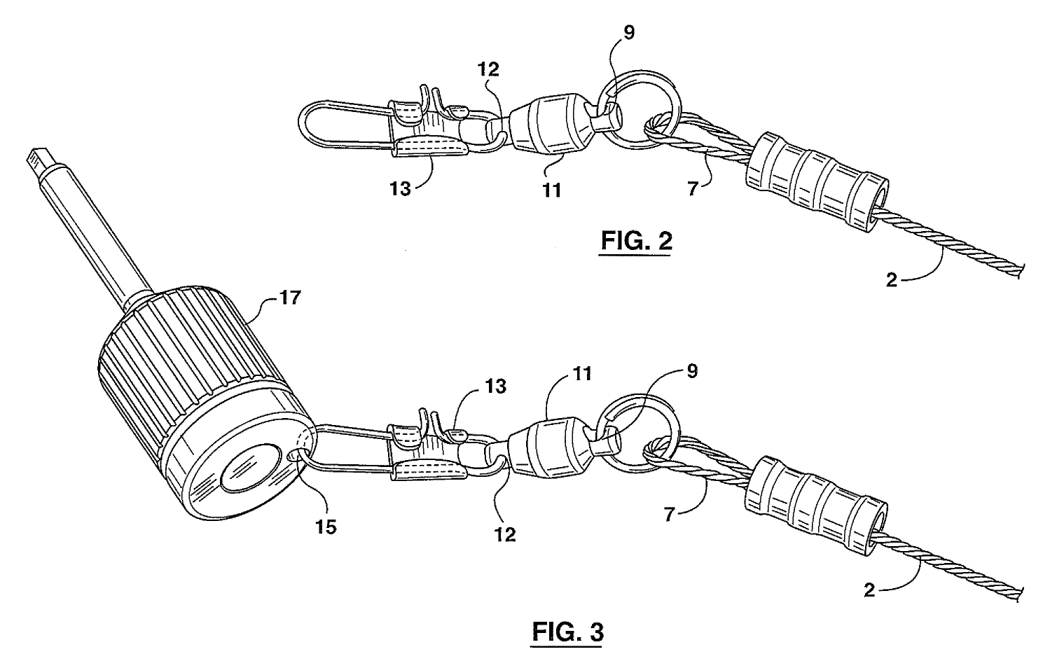

More in particular, as shown in FIGS. 1 through 3 of the drawings, the present embodiment of the present dental lanyard device 1 consists of a restraining strap 2, looped upon itself so as to form a restraining loop 3 operable to be affixed to an individual or an object, a free end 7 of the restraining strap 2 affixed to a first end 9 of a swivel member 11. The swivel member 11 is then connected from a second end 12 to a known fastening means 13 which in turn is connected to the dental device 17 by way of a bore hole 15 in the dental device 17. The restraining strap 2, the swivel member 11 and the fastening means 13 are preferably formed from a suitable material such as plastic, silicone, rubber, metal or specifically stainless steel or a combination therefrom.

In the present preferred embodiment, the restraining strap 2, the swivel member 11 and the fastening means 13 are preferably formed from a stainless steel or metal combination therefrom so as to permit the sterilization and subsequent reuse of the dental lanyard device 1 with each subsequent patient.

It should be further noted that in the present embodiment, the restraining loop 3 is self tightening by virtue of frictional forces and after being affixed, the restraining loop 3 may adopt a tighter appearance.

The present invention further contemplates differing fastening means 13 from the clasp member portrayed in FIG. 1. The fastening means 13 may be selected from the group consisting of clasps, split rings, break-away clasps, R-clip or hairpin clip to accommodate and attach most effectively and efficiently to the specific dental device 17 of interest.

Using the example of a dental procedure incorporating a tooth extraction, the fastening means 13 may further include bonding a small orthodontic bracket to a tooth. In this situation, it is well known by those skilled in the art that teeth particularly molars can be quite difficult to hold. During the procedure, it is quite common for the target tooth to be released from the grip of the extraction forcep during the removal. Should the tooth be dislodged with an elevator (i.e. pried or levered out of the socket), there isn't anything holding the tooth and it must be retrieved using another instrument before it may descend into the patient's oropharynx. In this example, the restraining loop may be affixed to the patient themselves or a stationary object such as a post or armrest of a chair so as to keep the dental practitioner's hands free to hold other extraction tools.

While the present embodiment detailed by the figures discloses a dental device 17 that is an implant wrench, the present invention can readily be attached to other dental devices 17 or medical devices. These devices are small, heavy and hand-held that can be used to adjust implant screws which are required to retain implant parts (i.e. abutments and crowns). Oftentimes, these implant parts need to be removed and/or replaced during the course of implant fabrication. This replacement requirement is even further exacerbated during the prosthetic (surface-structure fitting and attachment) treatment phase. As previously stated, in combination with the patient's saliva, these small devices can be difficult to retain especially when being used in the back of the patient's mouth.

The present invention may also encompass dental devices 17 such as endodotic files and reemers. These devices are small hand-held metal files with short finger-tip gripping handles which are used to clean debris and infected tissue from root canals. Similar to the implant wrenches and drivers, these files and reemers can be difficult to implement on posterior teeth not accounting for the duration of the procedures which may leave both the patient and the dental practitioner fatigued.

In addition, the present invention may be used for dental bridges. Dental bridges are custom metal castings oftentimes with porcelain facings that can be attached to teeth adjacent to a missing tooth space thereby replacing the lost dentition. Since these prostheses may require a lot of adjustment and refitting, they can readily be mishandled and make their way to the back of the patient's throat. As such, they should be properly affixed and secured to the practitioner so as to avoid this problem

Similarly, the present invention may be used to secure dental x-ray holders. X-ray holders secure x-ray film in the proper orientation, relative to the tooth. Patients dislike these devices because they tend to irritate the soft tissue of the gum during use. Before the x-ray is taken, the dental practitioner sets the holder and leaves the room. Upon return the device may have fallen down the patient's oropharynx and becoming irretrievable. The present invention could be readily affixed to the x-ray holder and subsequently affixed to the wrist of the patient so as to ensure that the x-ray holder does not make its way to the back of the patient's throat.

The present invention offers numerous advantages to the dental practitioner in that more than one device may used at a time thereby securing a whole series of devices and/or teeth. In addition, the swivel member 11 may be comprised of a 360 degree ball-bearing swivel which eliminates twisting or tangling of the restraining strap 2, which may be experienced using the recommended floss or safety string prior art.

The present invention is relatively noninvasive or intrusive. Since there isn't another foreign body present in the patient's mouth or contacting the patient's oral tissue surfaces, the patient may not be aware of the presence of the present invention as opposed to the recommended gauze throat screen or rubber dam. One problem reported by the use of these invasive devices is that they may activate the patient's gag reflex causing considerable discomfort during the dental procedure which can be minimized through the use of the present invention.

As discussed, the present invention can be manufactured from materials whereby it can be sterilized and reused on subsequent patients. In the past, the rubber dam, gauze throat screen or the floss ligatures would have to be disposed after each procedure due to health and sanitary concerns and their inability to be readily sterilized.

The present invention can provide additional time savings to the dental practitioner. Unlike the insertion of a rubber dam, gauze throat screen, or floss ligature, the present invention may be readily affixed to the dental device and quickly secured to the appropriate individual (i.e. the dental practitioner or the patient).

The present invention may be of particular use when treating patients with the following traits as described below:

Patients with cognitive disabilities and those individuals who may be physically or mentally challenged may benefit from the present invention. As they may not understand instructions provided by the dentist or able to respond to instructions as provided by the dentist, their responses may be unpredictable or inappropriate. There is an increased likelihood that the dental device may slip from the dental practitioner's fingers.

Similarly, sedated patients will not be able to respond to the dentist's instructions and their gag response may be reduced.

Elderly patients may not be capable of being fully reclined and can be less tolerant of long or technically difficult procedures in their mouths. As such, they may require more frequent coughing or throat-clearing breaks than the average youthful patient. To further exacerbate the situation, the dentist has reduced visibility and the patient is more likely to choke.

Pediatric dental patients combine elements as previously described in terms of a limited access to the oral cavity, possible sedation and reduced understanding of the potential risks of treatment.

In a second embodiment of the present invention, the dental lanyard device may be comprised of a restraining strap 2 with a free end 7 but the other end 5 is associated with an anchor and affixed to a spring-mounted rotatable spool so that the free end 7 is retractable by the rotation of the rotatable spool. The embodiment requires an additional restraining loop that secures the rotatable spool and is operable to be affixed to an individual (i.e. patient or dental practitioner) or an object. The free end 7 is subsequently attached to a first end 9 of the swivel member 11. The swivel member 11 is then connected by a second end 12 to a known fastening means 13 wherein the fastening 13 means may also secure the dental device 17.

In yet another preferred embodiment, the fastening means of the restraining loop is selected from the group consisting of Velcro™, zipper, clasp, elasticized loop or laced mechanism.

The invention described and claimed herein is not to be limited in scope by the specific preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A dental lanyard for attachment to a dental device comprising:
a restraining strap with a first end and second end wherein the first end is threaded through a loop at the second end so as to define a restraining loop which may be affixed to an individual;
a swivel member with a first end and a second end wherein the first end is attached to the first end of the restraining strap; and
a fastening means attached to the second end of the swivel member
wherein the fastening means may also secure the dental device.

2. The dental lanyard of claim 1 wherein the fastening means is selected from the group consisting of clasps, split rings, break-away clasps, R-clip or hairpin clip.

3. The dental lanyard of claim 1 wherein the restraining loop may be affixed to a wrist of an individual.

4. The dental lanyard of claim 1 wherein the dental lanyard is made from materials selected from the group consisting of plastic, silicone, rubber and metal.

5. The dental lanyard of claim 1 wherein the fastening means affixes to a bore hole defined on the dental device.

6. The dental lanyard of claim 1 wherein the dental device is selected from the group consisting of wrenches, drivers, endodotic files, reemers or x-ray holders.

7. The dental lanyard of claim 1 wherein the individual is a dentist or a patient.

8. The dental lanyard of claim 1 wherein the dental device is a patient's tooth and the fastening means encompasses bonding a dental bracket to said tooth.

9. A dental lanyard for attachment to a dental device comprising:
a restraining strap with a free end and an anchor end affixed to a spring-mounted rotatable spool so that the free end is retractable by the rotation of the rotatable spool;
a restraining loop connected to the rotatable spool and operable to be affixed to an individual;
a swivel member with a first end and a second end wherein the first end is attached to the first end of the restraining strap; and
a fastening means attached to the second end of the swivel member
wherein the fastening means may also secure the dental device.

10. The dental lanyard of claim 9 wherein the fastening means is selected from the group consisting of clasps, split rings, break-away clasps, R-clip or hairpin clip.

11. The dental lanyard of claim 9 wherein the restraining loop may be affixed to a wrist of an individual.

12. The dental lanyard of claim 9 wherein the dental lanyard is made from materials selected from the group consisting of plastic, silicone, rubber and metal.

13. The dental lanyard of claim 9 wherein the fastening means affixes to a bore hole defined on the dental device.

14. The dental lanyard of claim 9 wherein the dental device is selected from the group consisting of wrenches, drivers, endodotic files, reemers or x-ray holders.

15. The dental lanyard of claim 9 wherein the individual is a dentist or a patient.

16. The dental lanyard of claim 9 wherein the rotatable spool is stored in a housing affixed to the restraining loop.

17. The dental lanyard of claim 9 wherein the dental device is a patient's tooth and the fastening means encompasses bonding a dental bracket to said tooth.

18. The dental lanyard of claim 9 wherein the restraining loop may be secured to an individual using a known fastening means.

19. The dental lanyard of claim 18 wherein the fastening means of the restraining loop is selected from the group consisting of Velcro, zipper, clasp, elasticized loop or laced mechanism.
